(19) United States
(12) Patent Application Publication
(10) Pub. No.: US 2005/0035066 A1
(43) Pub. Date: Feb. 17, 2005

(54) Combining a solvent-activated reactor and a halogen for enhanced oxidation

(76) Inventors: Perry L. Martin, Yuba City, CA (US); Roy W. Martin, Downers Grove, IL (US)

Correspondence Address: GRAY CARY WARE & FREIDENRICH LLP, 2000 UNIVERSITY AVENUE, E. PALO ALTO, CA, 94303-2248, US

(21) Appl. No.: 10/953,795

(22) Filed: Sep. 28, 2004

Related U.S. Application Data
(63) Continuation-in-part of application No. 10/878,899, filed on Jun. 28, 2004.
(60) Provisional application No. 60/495,083, filed on Aug. 13, 2003.

(51) Int. Cl. C02F 1/76

(52) U.S. Cl. 210/753

(57) ABSTRACT

An improved oxidizing composition and a method of preparing it are presented. The improved oxidizing composition includes a solvent-activated reactor and a halogen component. The solvent-activated reactor generates one or more preselected oxidizing products when contacted by a main solvent. The halogen component is also added to the main solvent and synergistically performs oxidation. The oxidizing composition may be used to treat bodies of water such as pool and spa and to bleach materials. Some examples of the halogen component include calcium hypochlorite, trichloroisocyanurate, dichloroisocyanurate, lithium hypochlorite, dibromo-dimethylhydantoin, bromo-chloro-dimethylhydantoin, sodium bromide, sodium chloride, and a combination thereof.

### RELATED APPLICATION

This application is a Continuation-in-Part of U.S. patent application Ser. No. 10/878,899 filed on Jun. 28, 2004, the content of which is incorporated by reference herein in its entirety.

### FIELD OF INVENTION

This invention pertains to improving the efficacy of oxidation process.

### BACKGROUND

Aquatic facilities, such as swimming pools, become contaminated from various components in the environment such as dust, bacteria, and viruses, as well as from waste products produced by the bathers. To ensure that the pools can be enjoyed safely, the pool water is treated to reduce or eliminate chemical oxygen demand (COD) and/or total organic carbon (TOC) in the water. Typically, chlorine or bromine is used to disinfect the water and prevent viruses and bacteria from being transmitted among the bathers. Halogen donor compounds such as chlorine or bromine are also used to sanitize/oxidize waste products produced by the bathers.

To achieve an effective level of antimicrobial and viricidal activity, the oxidation potential of water must be sustained above a threshold value. Sustaining the oxidation potential is an uphill battle, as the oxidation potential is continuously reduced by contaminants' consumption of the sanitizing/oxidizing agent. Studies have confirmed that the effectiveness of chlorine/bromine-based sanitizers is significantly reduced with increased contaminant level. As used herein, the “contaminant” is any substance that reacts with and consumes the sanitizing/oxidizing agent. In swimming pool and other waters, contaminants often come in the form of organic compounds.

Sanitizing water would be relatively easy if the only type of contaminants were inorganic inert nitrogen gas using the well known breakpoint chlorination process. However, when the water also contains organic nitrogen waste products, the breakpoint chlorination process is significantly impaired. This impairment is at least partly due to the fact that organic nitrogen reacts with the sanitizing agent in a less desirable competing reaction. The competing reaction entails chlorine's reaction with the organic nitrogen to produce a volatile and irritating byproduct known as chloramine (NH₂Cl, NHCl₂, NCl₃, R₂NC1, RHNCl, where R represents an organic constituent). Because some of the chlorine is turned into chloramines by the organic nitrogen (instead of being turned into inert nitrogen by the inorganic nitrogen), the ability of chlorine (or other halogen)-based sanitizing/oxidizing agent to rid the water of inorganic nitrogen such as mono- and di-chloroamines is significantly impaired.

In applications such as swimming pool water, where both organic and inorganic nitrogen are present, organic nitrogen that forms chloramines competes for chlorine against inorganic nitrogen that forms inert nitrogen. Chloramines accumulate because chlorine is consumed more readily by the organic byproducts than the already partially oxidized chloramines. Accumulation of chloramines is undesirable for a number of reasons. First, chloramines are less effective as oxidizers than chlorine. Second, incomplete oxidation of the Total Organic Carbon (TOC) by reaction with chlorine produces trihalomethane (THM), which are known carcinogens.

Furthermore, chloramines and THM induce corrosion of metals and impose mild to severe irritation to bathers' eyes, skin, and respiratory systems.

To control disinfection rates and prevent the accumulation of chloramines, the organic byproducts must be effectively oxidized independently of chlorine, leaving chlorine free to react with the inorganic nitrogen. This way, the chlorine is free to disinfect the water by converting the inorganic nitrogen to inert nitrogen gas. Also, when the TOC is diminished, the potential for formation of THM by reaction between chlorine and the TOC is reduced. Thus, a method and composition for achieving breakpoint chlorination without accumulation of chloramines and formation of incomplete oxidation products is desired.

### BRIEF DESCRIPTION OF THE DRAWINGS

FIGS. 1A and 1B are depictions of different embodiments of an oxidizing composition in accordance with the invention.

FIGS. 2A, 2B, and 2C are schematic illustrations of the reactor wall while a chemical reaction occurs inside a solvent-activated reactor.

FIGS. 3A, 3B, 3C, and 3D show different stages of a solvent-activated reactor while a chemical reaction occurs inside the reactor.

FIG. 4 is a schematic illustration that the reactor of the invention may be used to form various oxidizer products.

FIGS. 5, 6, 7, 8, and 9 are illustrations of different embodiments of the oxidizing composition in accordance with the invention.

### SUMMARY

In one aspect, the invention is an oxidizing composition that includes a reactor wall enclosing a reactor space, an oxidizer reactant in the reactor space, a halogen component, and a barrier material separating the oxidizer reactant from the halogen component. The reactor wall allows permeation of a main solvent into the reactor space at a controlled rate. Upon being contacted by the main solvent, the oxidizer reactant generates an oxidizing product through a chemical reaction in the reactor space.

In another aspect, the invention is an oxidizing composition that includes a reactor with pores and a halogen component. The reactor includes a core and a reactor wall surrounding the core. About 10-80 wt. % of the core is an oxidizer reactant that, when contacted by a main solvent, generates an oxidizing product through a chemical reaction. The reactor wall controls the diffusion of the main solvent to the core through pores in the reactor wall. The reactor wall has a substantially lower solubility in the main solvent than the oxidizer reactant and oxidizing product such that the reactor wall remains substantially intact until generation of the oxidizing product is substantially complete. The halogen component is in contact with the main solvent. The halogen component may be one or more of calcium hypochlorite, trichloroisocyanurate, dichloroisocyanurate, lithium hypochlorite, dibromo-dimethylhydantoin, bromo-chloro-dimethylhydantoin, sodium bromide, sodium chloride, and a combination thereof.

The invention is also an oxidizing composition that includes a reactor wall enclosing a reactor space, an oxidizer reactant in the reactor space, and a halogen component deposited over the reactor wall. The reactor wall allows permeation of a main solvent into the reactor space at a controlled rate. When contacted by the main solvent, the oxidizer reactant generates an oxidizing product through a chemical reaction in the reactor space.

In yet another aspect, the invention is a method of preparing an oxidizing composition. The method entails forming a reactor wall that encloses a reactor space, placing an oxidizer reactant in the reactor space, and forming a section of halogen component that is separated from the oxidizer reactant by a barrier material. The reactor wall allows permeation of a main solvent into the reactor space at a controlled rate. Upon being contacted by the main solvent, the oxidizer reactant generates an oxidizing product through a chemical reaction in the reactor space.

The invention is also method of preparing an oxidizing composition by forming a reactor wall enclosing a reactor space, placing an oxidizer reactant in the reactor space, and depositing a halogen component over the reactor wall. The reactor wall allows permeation of a main solvent into the reactor space at a controlled rate. When contacted by the main solvent, the oxidizer reactant generates an oxidizing product through a chemical reaction in the reactor space.

### DETAILED DESCRIPTION OF PREFERRED EMBODIMENTS

Embodiments of the invention are described herein in the context of a swimming pool, and particularly in the context of disinfecting the swimming pool water. However, it is to be understood that the embodiments provided herein are just preferred embodiments, and the scope of the invention is not limited to the applications or the embodiments disclosed herein.

A “halogen component” is either a halogen donor or a compound capable of generating a halogen donor. A “main solvent” is a solvent in which the oxidizing composition of the invention is intended to carry out the oxidation reaction. Although the description treats water as the main solvent, the main solvent is not limited to water. A “pore” in the reactor wall includes any void or medium through which the main solvent can enter the reactor, such as a fissure or a channel. A “barrier material” separates the halogen component from the oxidizer reactant. An “oxidizer” is a substance that has oxidation potential and includes “oxidizer reactant” and “oxidizing product.” The oxidizers that are used as reactants are herein referred to as the “oxidizer reactants.” The oxidizers that are generated as a result of the oxidizer reactant's going through a chemical reaction are referred to as “oxidizing products.”

Due to the above-mentioned disadvantages of using a halogen to treat water that contains both organic and inorganic contaminants, one or more oxidizers are sometimes used in conjunction with the halogen. The oxidizers help remove TOC and prevent the accumulation of chloramines by allowing them to be oxidized. Also, unlike chlorine, oxidizers do not produce THMs.

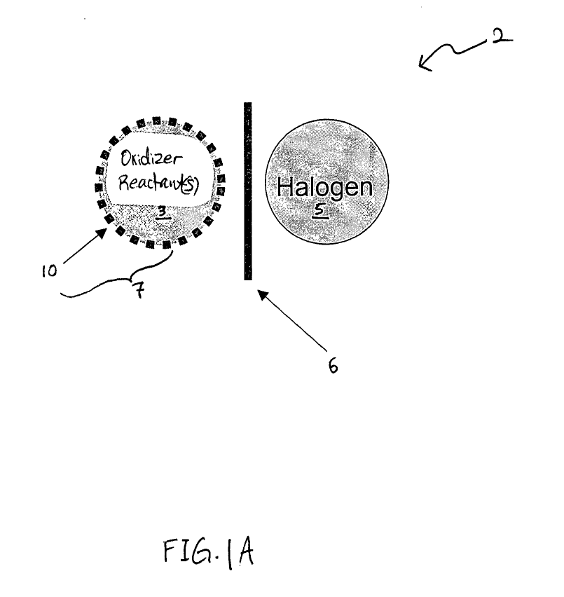

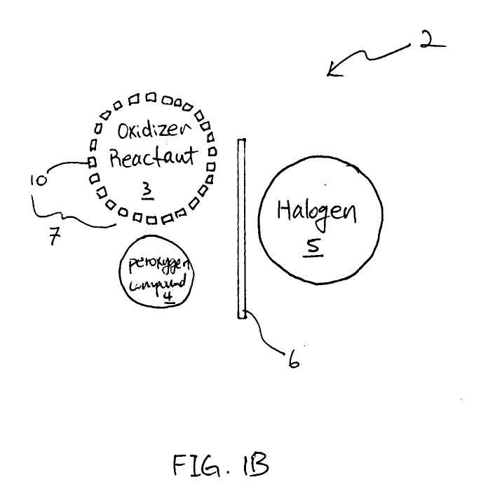

FIG. 1A is a depiction of an oxidizing composition 2 in accordance with the invention. As shown, the oxidizing composition 2 includes an oxidizer reactant 3, a reactor wall 10, a halogen component 5, and a barrier material 6. The reactor wall 10 is formed around the oxidizer reactant 3, which generates a desired oxidizing product when contacted by the main solvent. Typically, the oxidizer reactant constitutes about 4 to about 80 wt. % of the oxidizing composition. The halogen component 5 and the oxidizer reactant 3 are separated by the barrier material 6. This invention is based on the discovery that certain combinations of oxidizer(s) and halogen donor(s) provide a synergistic effect that substantially improves the efficacy of the oxidation process. Further, if the oxidizing composition 2 is combined with a detergent or bleach substance, the oxidizing composition 2 also improves the efficacy of the detergent/bleach composition. The product overcomes any incompatibility problem between the oxidizers and the halogen component by separating them with a barrier material. The barrier material allows the oxidizer(s) and the halogen component to be combined into a stable product. More details about the oxidizer reactant 3, the reactor wall 10, the halogen component 5, and the barrier material 6 are provided below.

If multiple oxidizing products are generated, the oxidizing products may be chosen based on their orders of selectivity to enhance the overall oxidation effect. For example, an oxidizing product such as N-chlorosuccinimide has been demonstrated to be very selective in breaking tryptophanyl peptide bonds, like those found in water-insoluble protein stains. Combining N-chlorosuccinimide with another oxidizing product such as dioxirane, percarboxylic acid, chlorine dioxide, or hydroxyl radicals makes for an effective combination with enhanced oxidation (e.g., bleaching) performance.

The oxidizer reactant 3 and the reactor wall 10 make up a solvent-activated reactor 7. The solvent-activated reactor 7 may also contain other components. The solvent-activated reactor 7 produces the oxidizing product in-situ, or in the environment where oxidation occurs. It is advantageous to produce the oxidizing product in-situ using a solvent-activated generator. When the solvent-activated reactor is placed in water, water seeps into the reactor through the wall, dissolves some of the reactants, and starts a chemical reaction that generates the desired oxidizer(s). A higher yield of the desired oxidizer is achieved by generating the oxidizer in a controlled reactor environment than if the reactants were thrown into a large body of water because high concentrations of reactants are maintained in the reactor. Furthermore, using a solvent-activated reactor is preferable to adding a pre-generated oxidizing product directly to the body of water because the oxidizing product is often unstable and becomes less effective during storage. The solvent-activated reactor is stable when dry but generates a predetermined oxidizing product when placed in contact with water.

Use of a solvent-activated reactor 7 is especially beneficial in applications where the oxidation environment is less than ideal. For example, the alkaline environment of laundry water is not well suited for generating acid catalyzed oxidizing products (e.g., hydroxyl radicals) or oxidizing products favoring near-neutral pH conditions (e.g., dioxirane). When the reactants are applied directly to this sub-ideal environment to form the oxidizing products, the yield is low and overall oxidation performance is impaired. By first generating the oxidizing products in the controlled environment of a solvent-activated reactor and then applying them to the body of water, more effective oxidation is achieved.

In one embodiment, the oxidizer(s) and the halogen component are encapsulated by one reactor wall. The oxidizer(s) and the halogen donor(s), however, have to be separated from each other so they do not react during storage, prior to being placed in contact with the main solvent. A barrier material may be used for the separation. In another embodiment, the oxidizer(s) and the halogen donor(s) are separated by the reactor wall. In yet another embodiment, solvent-activated reactors only contain reactants for generating oxidizer(s) and the reactors are physically mixed with halogen donor(s).

FIG. 1B is a depiction of an oxidizing composition 2 in accordance with another embodiment of the invention. In this embodiment, the oxidizing composition 2 includes a peroxygen compound 4 in addition to the oxidizer reactant 3, the reactor wall 10, the halogen component 5, and the barrier material 6. The peroxygen compound 4 is an oxidizer but, unlike the oxidizer reactant 3, is not used to generate an oxidizing product. Rather, the peroxygen component 4 itself enhances the oxidation process. The peroxygen compound 4 is separated from the halogen component 5 by the barrier material 6. The peroxygen compound 4 may be positioned inside the reactor wall 10 along with the oxidizer reactant 3. In that case, it is possible to treat some of the peroxygen compound 4 as the oxidizer reactant and the remaining peroxygen compound 4 as oxidation enhancer that does not react to generate the oxidizing product. The peroxygen compound 4 may be coated with a barrier film.

The peroxygen compound may be a potassium monopersulfate (PMPS) compound, such as a PMPS triple salt having the formula (KHSO₅)ₓ.(KHSO₄)_{y}.(K₂SO₄)_{z}. Preferably, the PMPS has a concentration of potassium oxodisulfate that is less than 0.5 wt. % of the triple salt because the oxodisulfate may be an irritant in some circumstances. The PMPS may be generated using the methods disclosed in U.S. patent application Ser. No. 10/878,169 and U.S. patent application Ser. No. 10/878,898, both of which are incorporated by reference herein. However, the peroxygen compound that is useful for this invention is not limited to the PMPS generated according to the above patent applications.

The oxidizing composition disclosed herein can be used directly in an aqueous solution such as a swimming pool or a spa. Alternatively, the oxidizing composition can be added to a cleaning composition such as a powdered laundry detergent, a scouring powder, a hard surface cleaning composition, a powdered automatic dishwashing composition, a non-aqueous automatic dishwashing composition, etc. Optionally, various other additives such as pH buffering agents, coagulants, clarifiers, algae control agents (e.g., boron or lanthanum based additives) may be included in the halogen-PMPS composition without deviating from the scope of this invention.

The compositions disclosed can be applied as a powder, formed into a conveniently-shaped solid, or used as a viscous gel.

Solvent-Activated Reactor

The solvent-activated reactor 7 allows for in-situ generation of multiple oxidizing products, thereby enhancing the overall oxidation process and providing for improved oxidation efficacy.

Solvent-activated reactor 7 technology includes a core and a reactor wall surrounding the core. The core contains an oxidizer reactant that, when combined with an oxidizable substance in an aqueous solution, produces the desired oxidizing product. Favorable reaction conditions are sustained inside the reactor and remains intact until the oxidizer reactant in the core has been depleted. The reactor wall is made of a coating material that is permeable to the main solvent (e.g., water) that is in contact with the solvent-activated reactor but restricts the oxidizer reactant and oxidizing product from diffusing out too fast. The reactor wall may be an agglomerate of colloidal particles such as that produced by meta-silicate in acid pH conditions, or can be a membrane, in which the porosity can be controlled during its formation to better control the diffusion rates. By restricting the diffusion rates of solvent to the core and reactor contents back to the bulk water, the reactants inside the reactor have sufficient time to react under favorable conditions that are best suited to produce the desired oxidizing product. For example, hydroxyl radicals, hypohalites, N-halo-amines and the like favor acid catalyzed conditions.

To maximize the yield in a chemical reaction, it is usually preferable to start with high concentrations of reactants because the molar concentrations of the reactants determine the rate of reaction and the subsequent product yield. Therefore, adding reactants to a large body of water to be treated is not an effective way to generate the desired product in-situ. Adding the reactants to the water lowers the reactant concentrations, and the resulting conversion of the reactants to the desired product(s) is generally poor. Another factor to be considered is the side reactions. When generating an agent in-situ, the oxidizer reactant is often consumed in reactions other than those desired for the in-situ production of the oxidizing product. Therefore, adding the reactants to the water to be treated results in more reagent requirements, longer reaction time, and/or an overall decreased yield of the oxidizing product.

Furthermore, the chemical environment, such as pH, can adversely affect the in-situ production of the oxidizing product. For example, reactions that are acid catalyzed are not supported in alkaline conditions such as laundry wash water. By isolating the reactants and controlling the conditions inside the reactor, efficient generation of the oxidizing product(s) occurs regardless of the conditions external to the reactor.

When an oxidizer, such as potassium monopersulfate (PMPS), is added to water to convert sodium chloride to hypochlorous acid oxidizing product a hypohalite reaction, the conversion or yield is dependent on the molar concentrations of the reactants. As described above, however, adding a given amount of reactants to a large volume of water yields poor conversion to the oxidizing product. Furthermore, potassium monopersulfate is highly reactive with organic chemical oxygen demand (COD). Thus, upon being exposed to the bulk solution, the PMPS reacts with the COD and further reduces the concentration of PMPS that is available to induce the hypohalite reaction.

The solvent-activated reactor 7 achieves a high yield of the oxidizing product by controlling the rate at which the reactants are exposed to water. More specifically, if the reactants were first exposed to a small volume of water and allowed to react to generate the oxidizing product, a high yield of the oxidizing product can be obtained because the reactant concentrations will be high. Then, the oxidizing product can be exposed to a larger volume of water without compromising the yield. The rate at which the reactants are exposed to water has to be such that the oxidizing product is generated in high-yield before more water dilutes the reactants. The invention controls the reactants' exposure to water by coating the reactants with a material that allows water to seep in and reach the reactants at a controlled rate.

Depending on the embodiment, the invention may be a reactor that is stable enough for storage and useful for generating high yields of products in-situ, product including oxidizers, biocides, and/or virucidal agents. A “soluble reactor” has a wall that dissolves in the main solvent after the reaction has progressed beyond a certain point such that the concentration of the oxidizing product is equal to or greater than a predetermined critical level. The soluble reactor is stable when dry. When mixed with a main solvent (e.g., water), however, the coating material that forms the outer wall of the soluble reactor allows the solvent to slowly seep into the inside of the reactor and react with the core. The core of the soluble reactor contains one or more reactants that, when combined with the main solvent, react to generate an oxidizing product. Since the concentrations of the reactants are high within the soluble reactor, a high yield of the oxidizing product is achieved inside the reactor. After the generated amount of the oxidizing product reaches a critical level, the coating material dissolves or dissipates, releasing the oxidizing product into the bulk solvent body.

In some embodiments, the reactor of the invention is a “micro-reactor” having a diameter or width in the range of 10-2000 μm. However, the reactor is not limited to any size range. For example, the reactor may be large enough to be referred to as a pouch or a tablet. A single reactor may be both a micro-reactor and a soluble reactor at the same time. Furthermore, a reactor may have a soluble wall and a non-soluble wall.

The reactor of the invention includes a core and a reactor wall surrounding the core. There may be additional layers, such as a protective layer for shielding the core from the environmental elements. The core contains an oxidizer reactant, an oxidizable reactant, or both. The reactor wall has a lower solubility than the reactants in the core or the oxidizing product that is produced in the reactor. The reactor wall controls the diffusion of water into the reactor and restricts the diffusion of reaction components out of the reactor. The rate at which water seeps into the reactor and the rate at which the oxidizing product leaves the reactor are controlled oxidizing product the porosity of the reactor wall.

The invention includes a method of preparing a reactor, wherein the reactor produces high concentrations of one or more oxidizing products that are different from the reactants enclosed in the reactor. The method of the invention allows the production of compositions that are stable for storage and, upon activation by contact with the solvent, produce a different composition in a high yield. It is the intent of the disclosure to illustrate exemplary methods of use for the various compositions.

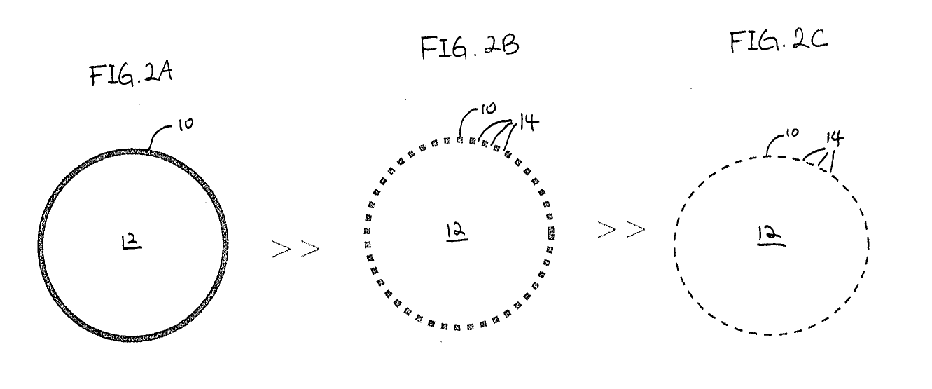

FIGS. 2A, 2B, and 2C are schematic illustrations of the reactor wall 10 while a chemical reaction is occurring in a reactor space 12 that is defined by the reactor wall 10. As shown in FIG. 2A, the reactor wall 10 is initially substantially solid, and oxidizer reactants (not shown) can be placed in the reactor space 12. When the reactor wall 10 encounters water, it slowly forms cracks or fissures 14 in the reactor wall 10, as shown in FIG. 2B. The water seeps into the reactor 7 oxidizing product the fissures 14, dissolves at least some of the reactants in the reactor space 12, and triggers a chemical reaction. Aside from the fissures 14, the reactor wall 10 remains substantially intact while the reactants react inside the reactor space 12 to generate the oxidizing product. However, once the reaction progresses to a critical level, the reactor wall 10 dissolves, as illustrated in FIG. 2C by the thinning of the reactor wall 10. In this embodiment, the reactor wall 10 eventually dissipates into the water, releasing the oxidizing product into the body of water. In other embodiments, the reactor wall 10 may not dissipate but remain as a hollow shell after generation of the oxidizing product is complete. Details about the composition of the reactor wall 10 are provided below.

One way to control the timing of the disintegration of the reactor wall is to select a reactor wall 10 whose solubility is a function of pH. In this case, the critical level is a certain pH level where the reactor wall 10 becomes soluble. If the solubility of the reactor wall 10 is impaired by the pH of the internal and/or the external solution, and the pH of the internal solution changes as the reaction in the reactor space 12 progresses, the reactor wall 10 will not become soluble until a certain pH is reached in the reactor (i.e., the reaction has progressed to a certain point). The reactions may occur in the reactor space 12 or along the inner surfaces of the reactor wall 10.

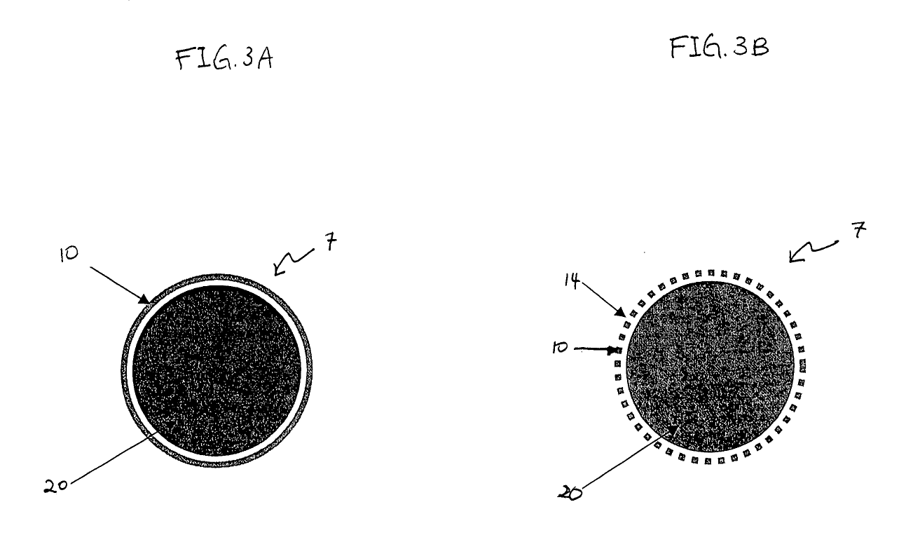

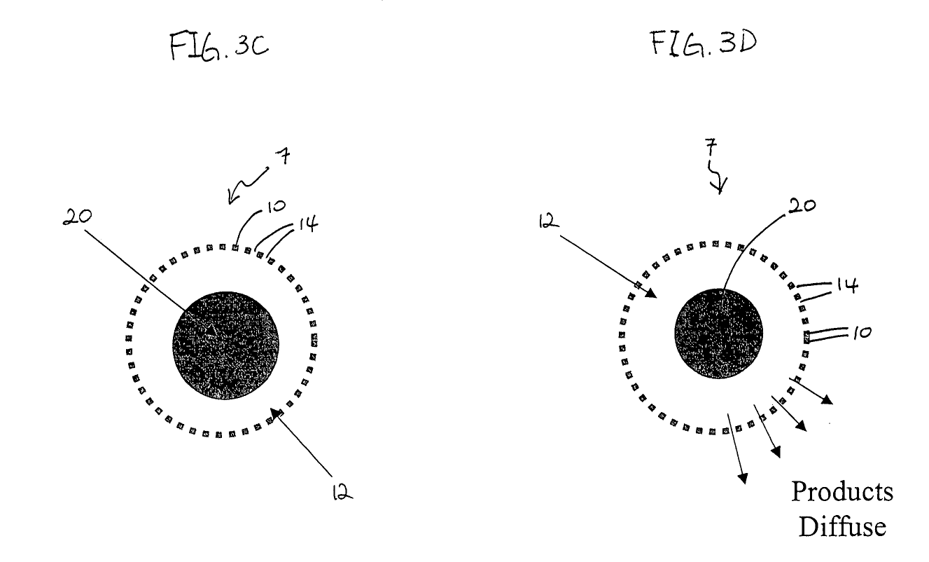

FIGS. 3A, 3B, 3C, and 3D show different stages of the reactor 7 undergoing a reaction. The reactor 7 has a core 20 in the reactor space 12. When in storage, the reactor wall 10 is intact and protects the core 20 from various environmental elements, as shown in FIG. 3A. When the reactor 7 is placed in the liquid to be treated, the reactor wall 10 begins to form the fissures 14 and the core 20 begins to dissolve, as shown in FIG. 3B. When dissolved, the components that form the core 20 become reactive and a chemical reaction begins. Since the amount of the water that permeates into the reactor space 12 is small, the components that form the core 20 (i.e., the reactants) remain high in concentration. As the chemical reaction progresses, the reactant concentration decreases, as shown by the decreasing size of the core 20 in FIG. 3C. When the concentration of the desired oxidizing product becomes high, the reactor wall 10 begins to disintegrate and the oxidizing product diffuses out of the reactor wall 10 into the water outside the reactor, as shown in FIG. 3D.

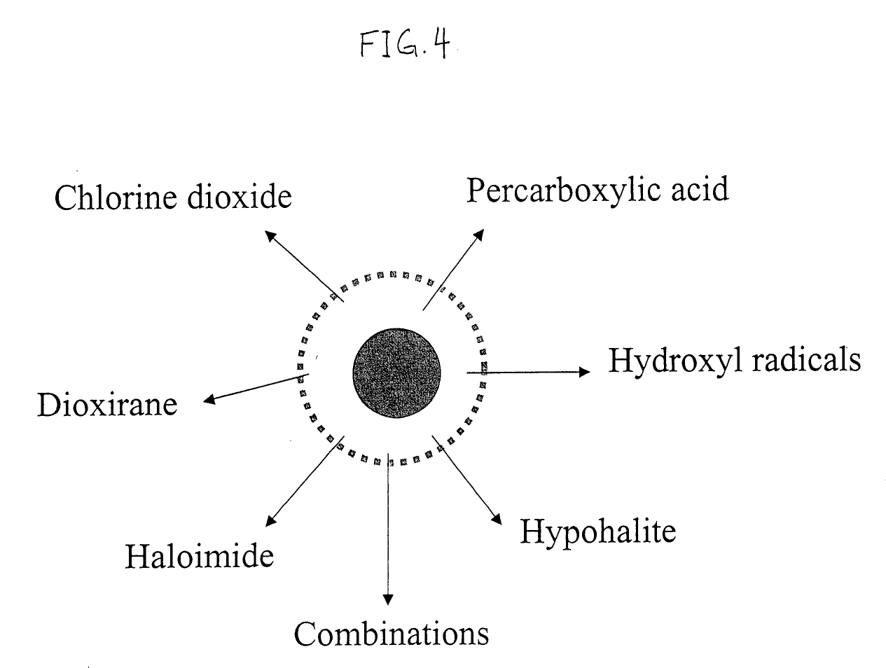

FIG. 4 is a schematic illustration that the reactor 7 may be used with any suitable reactions including but not limited to reactions that produce hypohalite, haloimide, dioxirane, hydroxyl radicals, percarboxylic acids, or chlorine dioxide. The reactor is useful for producing one or more of hypochlorous acid, hypochlorite, chlorine gas, hypobromous acid, hypobromite, bromine gas, N-halo-succinimide, N-halo-sulfamate, N-bromo-sulfamate, dichloro-isocyanuric acid, trichloro-isocyanuric acid, 5,5 dihalo dialkyl hydantoin, Hydroxyl radicals, oxygen radicals, peracids, and chlorine dioxide, and releasing the product into a body of water.

When producing multiple oxidizing products in-situ, the oxidizing products are selected based on compatibility of the oxidizing products and/or the reactants that produce the oxidizing products. Sometimes, the final oxidizers are compatible but the reactants used to produce them in-situ are not. A person of ordinary skill in the art will understand which substances are compatible.

Reactor Core

The oxidizer reactant in the core may be a peroxygen compound. The peroxygen compound may be, for example, monopersulfate, percarbonate, perborate, peroxyphthalate, sodium peroxide, calcium peroxide, magnesium peroxide, or urea peroxide. As for the “oxidizable reactant,” which may also be present in the core, it usually reacts with the oxidizer reactant to produce one or more oxidizing products. In some embodiments, the oxidizable reactant is a catalyst that is not consumed during its reaction with the oxidizer reactant. However, in some other embodiments, the oxidizable reactant is altered and consumed by the reaction with the oxidizer reactant.

The core 20 includes at least one oxidizer reactant that, upon dissolving, induces the in-situ generation of the desired oxidizing product(s). For example, the reactant may be a peroxygen compound such as a persulfate, inorganic peroxide, alkyl peroxide, and aryl peroxide. The core can be formed into any useful size and shape, including but not limited to a granule, nugget, wafer, disc, briquette, or puck. While the reactor is generally small in size (which is why it may also be referred to as a micro-reactor), it is not limited to any size range. The oxidizing products may include an oxidizer that is different from the oxidizer reactant. Some examples of oxidizers that can be used as reactants include perborates, percarbonates, sodium peroxide, lithium peroxide, calcium peroxide, magnesium peroxide, urea peroxide, perphosphate, persilicate, monopersulfate, and persulfate.

1) Exemplary Oxidizing Products

N-halo-amines, in particular N-halo-succinimide, are stable forms of chlorine that improve oxidation efficacy. N-halo-succinimides have improved selectivity for bonds like those found in tryptophanyl peptide bonds. Besides being able to effectively target selective classes of bonds to enhance selective bleaching applications, high selectivity has other benefits. N-halo-succinimide's ability to survive the organic soup making up cell fluids and external contaminants enhances its ability to perform its targeted function, which includes decomposing protein bonds (such as DNA) and fragments of water-insoluble proteins to smaller water-soluble sources of COD. Water-soluble COD is effectively decomposed with various oxygen radicals and peroxygen compounds. Halogenation reactions further enhance continuous breakpoint halogenation, as is well known. This synergistic effect dramatically enhances the application's performance. The N-halo-amine family of compounds includes N-halo-sulfamates, N-halo-cyanurates, and N-halo-hydantoins, among others.

Hydroxyl radicals are powerful oxidizers that react with organic COD. The reaction between hydroxyl radicals and organic COD does not entail oxygen or halogen transfer. Rather, the hydrogen cleavage of hydrocarbons induces radical formation, followed by auto-catalytic decomposition thereby further fragmenting larger compounds.

Percarboxylic acids are affective at oxidizing organic COD. Used in bleaching and disinfection applications, oxidation occurs from oxygen substitution. The organic acid byproduct can be a stable acid (un-reactive, such as succinic acid) or reactive with other oxidizers.

Dioxirane is a powerful oxidizer used in bleaching as well as organic synthesis applications. It is also an effective antimicrobial agent. Oxygen substitution is the primary oxidation reaction.

Chlorine Dioxide is an effective disinfect, and is used in various bleaching applications. Oxidizing product primary oxygen substitution, chlorine dioxide induces decomposition of many organic forms of COD.

Oxidizing products are not limited to the specific substances mentioned above, and may also be other substances such as hypohalite and singlet oxygen. Reactants are selected to induce the formation of the desired oxidizing product(s). When determining the ratio of reactants, consideration should be given to the desired ratio of oxidizing products. Single species generation of agent is achieved with proper optimization of reagent ratios.

2) Core Components Other Than Oxidizer Reactants

High conversion of reactants and good stability of products is achieved by adding stabilizers and/or pH buffering agents to the mixture of reactants. For example, to produce N-haloimides (also called N-halo-amines) such as N-chlorosuccinimide, N-succinimide is added to a mixture containing PMPS and NaCl. Also, an organic acid (e.g., succinic acid) and/or inorganic acids (e.g., monosodium phosphate) may be applied to ensure that the pH of the reactant solution is within the desired range for maximum conversion to the haloimide.

Binders are compounds that are used to combine the components in the core and hold them together, at least until they are coated, to provide a homogenous mixture of reactants oxidizing productout the core. Binders may not be necessary in some embodiments. Many different types of compounds can be used as binders including polymers with hydrophobic and/or hydrophilic properties (e.g. polyoxyethylene alcohol, fatty acid esters, polyvinyl alcohol,), fatty acids (e.g. myristic acid), alcohols (myristic alcohol), and polysaccharides such as chitosan, chitin, hydroxypropyl cellulose, hydroxypropyl methylcellulose and the like. The function of the binder is to provide an agglomerating effect without adding an undesirable amount of moisture so as to cause the reactants to dissociate and start reacting. In cases where solvent recovery apparatus is available during manufacturing, binder solvents can be used to promote better distribution of the binder as long as the solubility of the reactants in the binder solvent is low.

The binder may be a rheology-altering polymer/copolymer such as Carbopol® sold by BFGoodrich that is a family of polymer/copolymers comprised of high molecular weight homo- and copolymers of acrylic acid crosslinked with a polyalkenyl polyether. Rheology-altering polymers allow a wide range of core components to be combined by incorporating a non-solvent in the core. Either the oxidizer reactant or the oxidizable reactant is insoluble in the non-solvent. The presence of the non-solvent prevents activation of the components in the core, whereby the rheology-altering component binds the core components to provide a homogenous mixture. Depending on the embodiment, the non-solvent may become a part of the final composition, be partially removed, or be removed altogether. Since the non-solvent is usually not water, the final product may contain volatiles although it is substantially free of water (moisture). Sometimes, moisture may be used to enhance the formation of the agglomerate. However, in such cases, at least the oxidizer reactant should be coated to prevent its dissociation, the moisture should be well-distributed and used sparingly, and any moisture should be completely removed before long-term storage.

Fillers can be used or altogether omitted depending on the type of processing and the requirements of the use of the final product. Fillers are typically inorganic compounds such as various metal alkali salts and oxides, zeolites and the like. The fillers can enhance distribution of moisture when water is employed to enhance agglomeration.

A pH buffer, which is an optional component of the core, provides a source of pH control within the reactor. Even when alkaline water from laundry wash is used to dissolve the core, the pH buffers provide effective adjustment and control of the pH within the desired range to induce the desired reactions inside the reactor. PH buffers can be inorganic (e.g. sodium bisulfate, sodium pyrosulfate, mono-, di-, tri-sodium phosphate, polyphosphates, sodium bicarbonate, sodium carbonate, boric acid and the like). Organic buffers are generally organic acids with 1-10 carbons such as succinic acid.

Stabilizers are added when N-hydrogen donors are applied to generate N-haloimides in-situ. Examples of stabilizers include but are not limited to N-succinimide, N-sulfamate, isocyanuric acid, and the like. When stabilization is not required to generate these compounds, they can be omitted.

3) Core Configurations

Generally, the core composition is broken down as about 10-80 wt. % oxidizer reactant and about 1-20 wt. % oxidizable reactant, although there may be exceptions, as described above. The entire core is at least about 50 wt. % solids.

There are different configurations in which the core can be prepared, depending on the types of equipment available, the core composition, and the solubility characteristics of the core components.

A first configuration is a layered configuration wherein the different components form discrete layers. In this configuration, the oxidizable reactant is separated from the oxidizer reactant by a layer of a third component. This can be accomplished, for example, by spray coating or adding components in separate mixing stages, such as in a fluidized bed drier, to produce separate layers. When using this method, controlled diffusion rates oxidizing product the reactor coating is achieved to ensure that adequate reaction internal to the reactor happens prior to diffusion of the oxidizing product(s). The diffusion rates can be further controlled by arranging the layers such that the most soluble component makes up the innermost layer of the core.

A second configuration is a homogeneous core. In this configuration, the core components and the binder are combined and mixed to form a homogenous core. The binder can be any one or more of the compounds mentioned above, and one or both of the oxidizer reactant and the oxidizable reactant are immiscible with the binder. The mixing can be carried out in a blender/mixer, agglomerator, or a fluidized bed device. If there is moisture in the core, it can be either dried to remove any final moisture. If non-solvents are used to enhance agglomeration, moisture is removed even if other residual volatiles may remain. Alcohols, for example, which are compatible with potassium monopersulfate and can be formed into a gel or virtual solid by adding rheology modifiers like Carbopol®, may remain. Thus, although there may be volatile components in the final composition, the core is substantially free of moisture. Any reference to “drying” during processing the reactor refers to the removal of water, and does not necessarily imply that all volatiles are removed.

A third configuration includes a solution or gel. A slurry is prepared by suspending the core components in a solution or gel. The agent(s) used to suspend the components must have properties such that either one or both of the oxidizer reactant and the oxidizable reactant are immiscible in the solution or gel. The agents used as solution or gel can be either removed or can remain as part of the final core product.

The descriptions of various components and examples of said components are not meant to limit the invention. Other unspecified compounds that perform the same function are considered within the scope of the invention.

4) Producing the Core

The core is first produced by using any or a combination of suitable conventional equipment and techniques. Regardless of the equipment or technique, an effective amount of reactants are distributed within the reactor core. The term “effective distribution” is defined by the core's ability to generate the oxidizing product(s) when exposed to water. The components comprising the core can be fed into a mixer/densifier using high, moderate or low shear such as those sold under the trade names “LÖdige CB30” or “LÖdige CB30 Recycler,” a granulator such as those sold under the trade names “Shugi Granulator” and “Drais K-TTP 80”. In some cases, a binder can be combined to enhance core formation. The core components can also be fed into the mixer or agglomerator at separate stages as to form layers thereby separating the oxidizer reactant from the oxidizable reactant. This is relevant when moisture addition is involved in the processing. However, when solvents or binders are used in which at least one of the oxidizer reactant and the oxidizable reactant are immiscible, the core components can be combined in one single stage or in multiple stages.

Furthermore, a spray-drying tower can be used to form a granular core by passing a slurry of components oxidizing product the spray drier. The reactants and other components that make up the core are fed as a slurry to a fluidized bed or a moving bed drier, such as those sold under the trade name “Escher Wyss.” When using a fluidized bed or a moving bed drier, care must be taken to consider the solubility and reactivity of the components in the core. For example, a halide donor combined directly to the PMPS in a moist environment will give off chlorine gas. To prevent this chlorine emission, the PMPS may first be coated to prevent direct contact between the halide and moisture. Alternatively, an intermediate solvent may be used to shield the PMPS from the moisture. The intermediate solvent is selected such that either the coated PMPS or the halide salt is insoluble or have poor solubility (i.e., alcohols). A binder that is un-reactive with the oxidizer reactant can be combined into the core either before or during the spray drying or spray graining process to enhance agglomeration without compromising oxidizer activity.

In another aspect of the invention, the core components are combined in an alcohol solution that is thickened with a rheology modifier, and then dried in a spray drier, fluidized drier, or the like. This alcoholic gel improves the long-term storability of reactants such as PMPS by further preventing the reactants from coming into contact with water. More details about the alcoholic gel is provided in a copending U.S. patent application Ser. No. 10/913,976 filed on Aug. 6, 2004, which is entitled “Storing a Composition in an Alcoholic Gel.” The combining of the reactant components may be done in-situ during the fluidizing process. Alternatively, the components may be combined externally in a granulator, densifier, agglomerator, or the like prior to the fluidizing process.

Spray graining layers of core components is another way of preventing direct contact between the oxidizer reactant and precursors such as halides that may induce the production of halogen gas. This method is useful when membrane-based coatings are applied as described herein. The membrane-based coating sufficiently suppresses diffusion of the dissolved components oxidizing product the pores due to osmotic pressure. Molecular diffusion is sufficiently slow to allow for the reactants to dissolve and react prior to diffusion of the produced agent(s).

The oxidizer reactant of the core can be coated with an aqueous solution or slurry of the components that make up the remainder of the core while suspended in a fluidized drier system. The resulting core composition can be either dried and removed from this stage of the process, agglomerated while in the fluidized bed drier, or removed and further mixed using equipment such as the mixer/densifier discussed above.

To further enhance the processing options and maintain the activity of the oxidizer reactant, the oxidizer reactant may be coated independently of other core components to enhance its processing survivability. The coating material may include inorganic and organic materials such as silicates, alkali metal salts, cellulose, polysaccharides, polymaleic acid, polyacrylic acid, polyacrylamindes, polyvinylalcohols, polyethylene glycols, and their surrogates/derivatives. The coating must have sufficient solubility when exposed to the environmental conditions inside the reactor. For example, alkali metals salts such as magnesium carbonate function as anti-caking agents for some oxidizers and enhance the oxidizer's processing survivability. However, when exposed to an acidic environment, the alkali rapidly dissolves, exposing the core 20.

Chitosan is another example of a coating that improves the product's process survivability and hygroscopicity. Under normal storage conditions, when exposed to acidic conditions and in particular organic acids, the polymer becomes very hydrophilic and rapidly dissolves, exposing the core 20. This condition can be exploited by including organic acid donors such as succinic acid into the core composition when using chitosan-coated core. Chitin may also be used instead of chitosan.

Multiple oxidizers can be generated by altering the ratio of core components. Combining reactants to produce N-chlorosuccinimide, hypochlorous acid, and chlorine dioxide can provide synergistic effects from one product by using multiple mechanisms of oxidation.

Examples of oxidizable reactants consumed or altered in the reaction with the oxidizer include but are not limited to: halogen donors such as NaCl and NaBr, organic carboxylic acids having from 1-10 carbons and at least 1-carboxylic acid (COO—) group such as citric acid or acetic acid donors, ketones, and aldehydes. Examples of oxidizable substances not consumed or altered in the reaction are: transition metal donors such as iron or copper salts or bound by chelants.

Reactor Wall

After the reactants are selected, the coating material for encapsulating the reactants is selected. With proper selection of coating material based on its solubility in water, water permeates through the coating and activates the reactants inside by dissolving them. At the same time, the reactants are contained within the walls of the coating and not allowed to diffuse out oxidizing product the coating until the reaction has progressed beyond a critical point. By restricting the diffusion of reactants, their respective molar concentrations inside the coating remain high, increasing the yield of the agents.

The pores and other openings in the reactor wall allow the oxidizing product to migrate out of the reactor. Initially, osmotic pressure on the reactor wall increases, thereby squeezing the main solvent into the reactor. A controlled permeation of the oxidizing product from the inside of the reactor occurs to prevent the reactor wall from rupturing. This permeation is enhanced by the gas(es) often produced during the chemical reaction in the reactor. The rate of permeation both into and out of the reactor is controlled by the size and the number of the pores in the reactor wall.

Two properties are desirable in the coating material: 1) it allows for adequate permeation of water to dissolve the reactants in the core, thereby triggering a chemical reaction inside the reactor, and 2) it acts as a barrier for preventing the reactants from diffusing out to the water body before the reaction has progressed enough to have generated a predetermined level of the desired oxidizing product. Both of these properties depend on the solubility of the coating material, which in turn may depend on the surrounding conditions (e.g., pH, solvent type). Thus, the elements surrounding conditions should be taken into consideration when choosing the coating material.

1) Silicate-Based Material

In a first embodiment of the reactor wall, the coating material is silicates, silicones, polysiloxane, and polysaccharides including chitosan and chitin. The silicate-based coating material may be something that contains silicate, such as metasilicate, borosilicate, and alkyl silicate.

How suitable a particular coating material is for a given application depends on the surrounding conditions. For example, silicate coatings are well established for providing a barrier material of protection to percarbonates and other oxidizers used in laundry detergents. In laundry detergents, the inclusion of bleach precursors such as tetraacetyl-ethylenediamine or nonanoyl-oxybenzene sulfonate to enhance the bleaching performance in low temperatures is common. The hydrolysis of the precursors requires alkaline pH conditions. In such applications, due to the hydrolysis requirements and peroxygen chemistry, the internal and external solution used to dissolve the reactants is high in pH. The silicate coating is soluble under alkaline conditions, and the integrity of the reactor wall is compromised. The coating dissociates rapidly, without acting as a reactor. In this case, the benefit of the high reaction yield is not achieved.

Silicates provide for a simple and inexpensive reactor coating when used in lower pH applications or formulations that result in internal acidic pH conditions that sustain the integrity of the reactor wall. This usefulness of silicates remains uncompromised even if the external conditions are alkaline in pH, such as in the case of laundry water. Silica solubility is poor at low pH. At lower pH, silica remains colloidal and forms a colloidal gel. When monopersulfate (MPS) and a source of chloride such as NaCl are encased within a coating of silicate such as sodium silicate, then added to water, the water permeates oxidizing product fissures and cracks in the coating and dissolves the reactants. The resulting low pH (<5) from the dissolving MPS suppresses the dissolution rate of the surrounding silica, and the silica remains as a colloidal gel.

Inside the space enclosed by the silica gel coating, the concentration of reactants remains high and the resulting reactions produce high yields of chlorine gas. Upon diffusion of the reactants and the chlorine into the surrounding water, hypochlorous acid and hypochlorite ions form as a function of the water's pH. The resulting conversion to the oxidizing product is therefore much higher when the pH inside the reactor is low and the reactor wall remains undissolved. With the inclusion of N-succinimide, it is now possible to produce N-chlorosuccinimide with the slow-diffusing chlorine gas. pH buffers can be added to further ensure efficacy based on application requirements. In alkaline pH conditions such as laundry bleaching, the elevated pH will not allow for generation of the N-chlorosuccinimide. By sustaining the integrity of the reactor, the internal conditions of the reactor are such that the reactions are successfully carried out. The oxidizing product is efficiently generated and released.

2) Hydrophobic Polymer

In a second embodiment of the reactor wall, the reactor wall is made of a generally hydrophobic substance that includes hydrophilic constituents. A mixture of hydrophobic and hydrophilic substance is applied to the core and dried. Upon addition of water, the hydrophilic component dissolves and the hydrophobic polymer remains intact, forming a porous shell around the core. Water permeates through the pores to reach the core and trigger a chemical reaction. Then, eventually, after the product concentration reaches the critical level, the hydrophobic substance might dissolve. More details about this coating process are provided below.

Applications where alkaline pH aquatic conditions are achieved or increased control of diffusion rates is desired can utilize hydrophobic coatings combined with hydrophilic agents. This hydrophobic coating material may be useful with an alkaline-pH aquatic environment where the silicate coating is ineffective as a reactor. As mentioned above, hydrophobic coatings may possess hydrophilic portions, such as some hydrophilic functional groups inherent in the polymer structure. However, the hydrophobic coatings have a hydrophobic backbone that limits their solubility substantially, thereby allowing them to effectively function as a reactor by maintaining the integrity of the reactor walls until the reaction inside has progressed beyond a critical point. This critical point may be defined by a condition such as the pH of the solution inside the reactor or the concentration of the oxidizing product.

Examples of hydrophobic polymers include but are not limited to Polyoxyethylene alcohols such as R(OCH₂CH₂)ₙOH, CH₃(CH₂)ₘ(OCH₂CH₂)ₙOH, and polyoxyethylene fatty acid esters having the general formula RCOO(CH₂CH₂O)ₙH, RCOO(CH₂CH₂O)ₙOCR, oxirane polymers, polyethylene terephthalates, polyacrylamides, polyurethane, latex, epoxy, and vinyl, cellulose acetate. Suitable hydrophilic components include but are not limited to: polycarboxylic acids such as polymaleic acid, polyacrylic acid, and nonionic and anionic surfactants such as ethoxylated or sulfonated alkyl and aryl compounds.

The non-solvent is generally hydrophilic and is removed after the application of the coating to leave voids and channels. The amphipathic agent is used to combine the polymer coating with the hydrophilic non-solvent. The resulting coat is usually micro-porous but the process may be altered to form macro-porous voids and channels. The ratio of solvent to non-solvent as well as non-solvent selection can be adjusted to provide varying degrees of pore size, distribution, and symmetry.

Polysiloxane emulsified in water using water-soluble surfactants provides for an effective coating in pH-sensitive applications. The emulsion is applied to the composition's core (i.e., to the reactants) and then dried, as is performed in the application of the silicates. However, when exposed to water, the hydrophilic component dissociates, forming pores in the hydrophobic polysiloxane coating. The water then permeates into the reactor dissolving the core and activating the reactants. The reactions produce the desired oxidizing products in high yield, and these oxidizing products act on the bulk body of water when the reactor wall dissolves. Due to the high chemical stability of the polysiloxane, the integrity of the reactor coating remains uncompromised in alkaline pH conditions.

3) Porous Membrane

In a third embodiment of the reactor wall, the reactor wall 10 is a hydrophobic and porous membrane. A second coating can be applied to improve the shelf life in high-humidity storage conditions. To further improve on the diffusion rates by providing for a controlled porosity and pore symmetry, the hydrophobic components such as cellulose acetate can be dissolved in a solvent and combined with a non-solvent that is amphipathic or has a hydrophilic functionality. After forming the coating, both the solvent and non-solvent are removed (e.g., evaporated) leaving a coat with specific porosity. The porosity can be altered by controlling the ratio and types of non-solvent and solvent to the hydrophobic component. For example, addition of ethanol into a mixture of acetone/water-magnesium perchlorate (solvent/non-solvent mixture) produces asymmetrical pores. “Solvents” have the ability to dissolve the hydrophobic polymer while being soluble in the non-solvent.

The hydrophobic component can be any number of thermoplastics and fiber forming polymers or polymer precursors, including but not limited to polyvinyl chloride, polyacrylonitrile, polycarbonate, polysulfone, cellulose acetates, polyethylene terephthalates, and a wide variety of aliphatic and aromatic polyamides, and polysiloxane. Using this coating technology, a membrane with controlled porosity is produced. Representative synthetic polymers include polyphosphazines, poly(vinyl alcohols), polyamides, polycarbonates, polyalkylenes, polyacrylamides, polyalkylene glycols, polyalkylene oxides, polyalkylene terephthalates, polyvinyl ethers, polyvinyl esters, polyvinyl halides, polyvinylpyrrolidone, polyglycolides, polysiloxanes, polyurethanes and copolymers thereof. Other suitable polymers include, but are not limited to, methyl cellulose, ethyl cellulose, hydroxypropyl cellulose, hydroxypropyl methyl cellulose, hydroxybutyl methyl cellulose, cellulose acetate, cellulose propionate, cellulose acetate butyrate, cellulose acetate phthalate, carboxymethyl cellulose, cellulose triacetate, cellulose sulfate sodium salt, poly(methyl methacrylate), poly(ethyl methacrylate), poly(butyl methacrylate), poly(isobutyl methacrylate), poly(hexyl methacrylate), poly(isodecyl methacrylate), poly(lauryl methacrylate), poly(phenyl methacrylate), poly(methyl acrylate), poly(isopropyl acrylate), poly(isobutyl acrylate), poly(octadecyl acrylate) polyethylene, polypropylene, poly(ethylene glycol), poly(ethylene oxide), poly (ethylene terephthalate), polyvinyl acetate), polyvinyl chloride, polystyrene, polyvinyl pyrrolidone, and polyvinyiphenol. Representative bioerodible polymers include polylactides, polyglycolides and copolymers thereof, poly(ethylene terephthalate), poly(butic acid), poly(valeric acid), poly(lactide-co-caprolactone), poly[lactide-co-glycolide], polyanhydrides, polyorthoesters, blends and copolymers thereof.

More specifically, cellulose acetate phthalate such as CA-398-10NF sold by Eastman Chemical Company may be used as the coating material. Under low pH conditions like those previously described for production of N-chlorosuccinimide, the coating remains stable. However, when the core components are depleted, the higher pH (>6.0) dissolves the reactor wall. The porosity can be controlled by dissolving the cellulose in a solvent, then adding an effective amount of non-solvent. After application of the coating, the solvent and non-solvent are removed via evaporation, leaving behind a membrane with a distinct porosity. The porosity can be further altered in symmetry, number of pores, and size of pores by altering the coating components and processing. For example, a decrease in solvent to polymer (S/P) ratio, an increase in nonsolvent/solvent (N/S) ratio, an increase in nonsolvent/polymer (N/P) ratio in the casting solution composition, and a decrease in the temperature of the casting solution tend to increase the average size of the pores on the surface of resulting membranes. Further, an increase in S/P ratio in the casting solution composition, and an increase in the temperature of the casting solution, tend to increase the effective number of such pores on the membrane surface.

Some applications may benefit from a membrane that provides a long term treatment with antimicrobial agents. After the core is extruded, the membrane coating is formed by either directly applying a film-forming membrane and evaporating off any solvents (including water) and non-solvent in the membrane. Alternatively, after the core is extruded, the phase inversion process may be used to produce long fibrous solvent-activated reactors that can be woven or combined with woven materials. The membrane formation process will now be described.

To further improve the stability of the formed polymer membrane, an alloy component can be incorporated into the membrane to form an alloyed reactor wall membrane. For example, addition of poly(phenylene oxide dimethyl phosphonate) to cellulose acetate on a 1:1 w/w mixture can increase membrane tolerance from a pH of <8 to a pH of 10-10.7 for extended usage. An alloying compound is typically an organic component that is combined with the primary hydrophobic component that enhances the polymer membrane's chemical and/or thermal stability. The alloying compound can also be a cross-linking agent such as triflic acid with phosphorous pentoxide, trifluoromethansulfonate, etc., or a plasticizer.

In some embodiments, a cross-linking agent that enhances the structural integrity and rigidity with a polymer precursor such as styrene is included in the reactor wall. Styrene, a cross-linking agent such as divinylbenzene, a solvent, and non-solvent are mixed and applied to form an effective film, followed by the step of initiating polymerization by applying a persulfate or activating peroxide solution before removing the solvent and non-solvent by evaporative drying. The persulfate may be applied during the removal of the solvent and non-solvent, in situ. After the drying, a plastic coating layer having a micro- or macro-porous structure with substantially improved rigidity and strength is obtained.

A plasticizer may also be used to increase the pliability as well as alter the hygroscopicity of the membrane coating.

Alloying compounds such as plasticizers and cross-linking agents may be incorporated into the reactor wall to further improve its structural integrity and/or stability across different temperature and pH ranges. As stated above, the alloying component can also be a cross-linking agent such as triflic acid with phosphorous pentoxide, trifluoromethansulfonate, and the like.

4) Multiple Reactor Walls

A single reactor may contain more than one reactor wall. For example, a silicate-coated-core can be further treated with a second coating of chitosan to improve its fluidity and hygroscopic properties. Upon exposure to a bulk quantity of water, the chitosan is dissolved and the silica-coated reactor is exposed. Also, where enhanced storage stability is required, such as high humidity exposure, a secondary coating that enhances the hygroscopicity of the reactor-encased composition may be applied. The invention is not limited to a specific number of reactor wall. Examples of dual-reactor embodiments are provided below. Reactors may also be prepared with more than two layers of reactor walls, depending on the application.

5) Forming the Reactor Wall

The coating material for forming the reactor wall 10 may be applied to the core 20 in the form of an aerosol, a liquid, an emulsion, a gel, or a foam. The preferred form of coating depends on the composition of the coating being applied, the application equipment, and conditions. The coating generally comprises from 0.2 to 5% of the total weight of the solvent-activated reactor. However, the actual amount of membrane coating can vary based on the size of the reactor, porosity and the like.

In one aspect, the invention is a method of producing the reactor described above, and also a method of using the reactor to treat an aquatic system. The invention is a method of generating high yields of oxidizers, biocides and/or virucidal agents in-situ by using the reactor that is described above. The reaction in the reactor is triggered when the reactor is exposed to the body of water that is to be treated by the products of the reaction.

The core that is formed as described above is coated with an effective amount of coating material. The “effective amount” of coating takes into consideration the solubility characteristics of the coating under the conditions in the application so as to ensure that the structural integrity of the reactor remains sufficiently intact until such time as the reactants have been depleted. The coating material may be applied by using any effective means of distributing the coating material over the surface of the core, such as spray coating in a fluidized bed, or applying a foam or liquid containing the coating material and mixing. Then, the coated composition is dried by using an effective means of drying, such as a fluidized drier or a tray drier, rotary drier and the like.

Once the core has been produced, the coating is effectively applied in the form of liquid, foam, gel, emulsion and the like. The coating can be applied by aerosol, spray, immersion and the like. The coating may be applied with a mechanical mixing device such as a blender/mixer, then dried using any number of batch or continuous drying techniques such as tray driers, rotary driers, fluidized bed driers, and the like. The preferred technique is to accomplish coating and drying in a continuous fluidized bed drier. The fluidized bed drier can incorporate multiple stages of drying to apply multiple applications of coating, perform different steps in the coating process (i.e., coating, polymerization, evaporation) and the like under continuous or batch processing. Generally, the product temperature during the coating process should not exceed 100° C. and preferably 70° C. During membrane coating, the application of the coating should occur at <50° C. and preferably <30° C. depending on the solvent and non-solvent that are used.

The order of application, evaporation, drying, etc. of the coating material varies based on the types of polymers, solvents, non-solvents and techniques used to produce the porous membrane. For example, a cellulose acetate membrane is effectively applied by first dissolving the cellulose polymer in a solvent, then adding a non-solvent such as water and magnesium perchlorate to produce the gel. The gel is coated on the core by spraying or otherwise applying a thin film of gel onto the surface of the core, then evaporating the solvent and the volatile components of the non-solvent.

A polyamide membrane can be produced by using the method that is commonly referred to as the “phase inversion process.” The phase inversion process includes dissolving a polyamide in a solvent such as dimethyl sulfoxide to form a gel, applying the gel to form a thin film, then applying the non-solvent to coagulate the polymer. Then, the solvent and non-solvent are evaporated.

Halogen Component

The halogen component, which may constitute about 29 to about 95.8 wt. % of the oxidizing composition 2, may be a halogen donor or a compound that generates a halogen donor. The halogen donor may be one or more of calcium hypochlorite, trichloroisocyanurate, dichloroisocyanurate, lithium hypochlorite, dibromo-dimethylhydantoin, bromo-chloro-dimethylhydantoin, sodium bromide, sodium chloride, and a combination thereof.

The halogen component 5 may be shaped into a useful solid form by using established processing techniques. If the halogen component 5 is granular, it may be produced using rotary mixers and/or rotary driers. Alternatively, a spray graining technique may be used with a fluidized drier. It may be produced by combining and mixing the components of the composition and applying pressure to a mold or extruding the objects of the desired shape. Optionally, a well-known binding agent may be used to enhance the cohesiveness of the particles. The pressure level that is applied during extrusion may be adjusted according to the desired hardness of the end product.

The halogen component 5 may be, but does not have to be, coated with the barrier material 6.

Barrier Material

The barrier material 6, which may constitute about 0.2 to about 10 wt. % of the oxidizing composition 2, includes one or more of an inorganic salt, silicate, borosilicate, and an organic polymer. Preferably, the barrier material 6 dissolves in the main solvent.

The inorganic salt may be one or more of sodium carbonate, sodium bicarbonate, sodium hydroxide, or an oxide, silicate, or borate that contains sodium. Alternatively, the inorganic salt may be potassium carbonate, potassium bicarbonate, potassium hydroxide, or oxide, silicate, or borate containing potassium. The inorganic salt may also be magnesium carbonate, magnesium bicarbonate, magnesium hydroxide, or an oxide, silicate, or borate containing magnesium. The inorganic salt may also be calcium carbonate, calcium bicarbonate, calcium hydroxide, or an oxide, silicate, or borate containing calcium.

The silicate may contain one or more of sodium, potassium, or lithium, and may be an alkyl silicate or a borosilicate.

The organic polymer may include one or more of chitin, chitosan, polymaleic acid, phosphinocarboxylic acid, carboxylate-sulfonate copolymer, a carboxylate-sulfonate terpolymer, or polysiloxane. The carboxylate component of the carboxylate-sulfonate copolymer or the carboxylate-sulfonate terpolymer is derived from either polyacrylic acid, polymethacrylic acid or polymaleic acid. The sulfonate portion of the carboxylate-sulfonate copolymer or the carboxylate-sulfonate terpolymer is derived from an aliphatic compound (e.g., methacrylamido methyl propane sulfonic acid) or an aromatic compound (styrene sulfonic acid). The terpolymer of the carboxylate-sulfonate terpolymer incorporates a nonionic component such as (meth)acrylamide, substituted (meth)acrylamide, vinyl alcohol, allyl alcohol, vinyl esters, an ester of vinyl or allyl alcohol, styrene, isobutylene or diisobutylene.

Combining Solvent-Activated Reactor and Halogen Component

As described above in reference to FIG. 1A and FIG. 1B, the solvent-activated reactor 7 and the halogen component 5 are separated by the barrier material 6. Several configurations are possible to achieve this separation. For example, the barrier film 6 may be formed over or under the reactor wall 10. Alternatively, the barrier film 6 may be formed over the halogen component 5. FIGS. 5-9 illustrate some exemplary configurations of the oxidizing composition 7.

### 1) EXAMPLE 1

FIG. 5 is a depiction of a first embodiment whereby the oxidizer reactant 3 is coated by the barrier material 6, which in turn is coated by the halogen component 5. The oxidizer reactant 3, the barrier material 6, and the halogen component 5 are all inside the reactor space defined by the reactor wall 4.

### 2) EXAMPLE 2

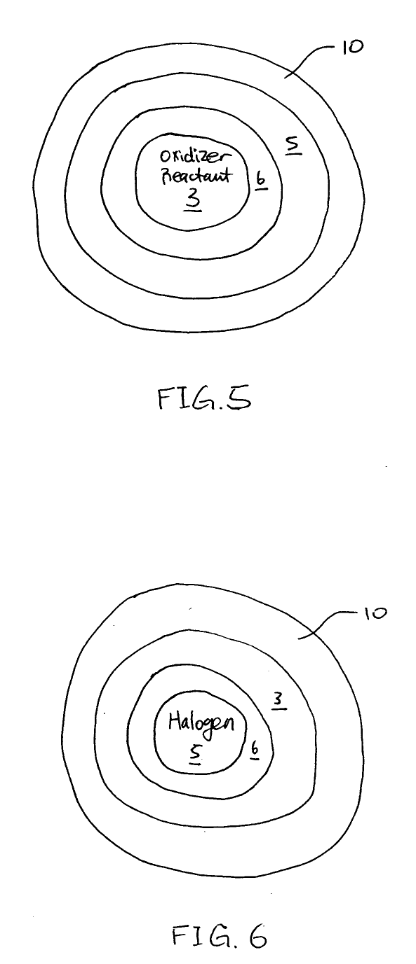

FIG. 6 is a depiction of a second embodiment that is similar to the first embodiment (of FIG. 5) except that the positions of the halogen component 5 and the oxidizer 3 are switched. In this embodiment, the halogen component 5 lies at the innermost layer of the oxidizing composition 2 and is coated by the barrier material 6 and the oxidizer 3, in that order. The reactor wall 4 surrounds the oxidizing composition 2, the barrier material 6, and the oxidizer 3.

### 3) EXAMPLE 3

FIG. 7 is a depiction of a third embodiment whereby the halogen component 5 is coated with the barrier material 6, and the coated halogen component and the oxidizer 3 are surrounded by the reactor wall 4.

### 4) EXAMPLE 4

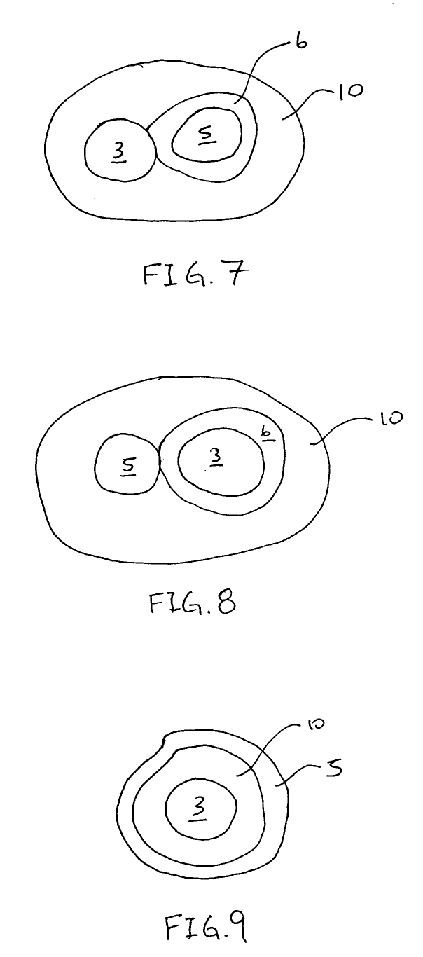

FIG. 8 is a depiction of a fourth embodiment of the oxidizing composition 2. In this embodiment, the oxidizer 3 is coated with the barrier material 6 and placed inside the reactor wall 4 with the halogen component 5.

### 5) EXAMPLE 5

FIG. 9 is a depiction of a fifth embodiment of the oxidizing composition 2 whereby the reactor wall 4 also functions as the barrier material. Unlike the embodiments above, the outermost layer in this embodiment is not the reactor wall 4. Rather, the halogen component 5 is coated over the reactor wall 10 and the oxidizer reactant 3 is in the reactor space. In this embodiment, the reactor wall 4 not only controls the rate at which the main solvent permeates into the reactor space and the rate at which the oxidizing product leaves the reactor space but also separates the oxidizer 3 in the reactor space from the halogen component 5 that is outside the reactor space.

The oxidizing composition 2 may be added to the body of water to be treated in any conventional manner specific to the application. For example, where the oxidizing composition 2 is used for pool treatment, it may be inserted into a feeder or a strainer at any location in the pool, or added to a pool circulating system that is continuously or periodically immersed in the water to be treated. Preferably, the oxidizing composition 2 is released in a controlled manner (as opposed to all at once).

The oxidizing composition 2 may be used in a liquid form. To prepare the liquid form of the oxidizing composition 2, the solid form of the composition is dissolved in water (e.g., using a tank with a mixer and a pump) before being applied as a treatment. A chemical feeder which contains the oxidizing composition 2 may be used to dissolve some or all of the composition before using the solution. Using the chemical feed, the composition may be applied by periodically using a timer, or by manually or automatically activating the feed system. The method allows for frequent incremental feed or continuous feed of the composition even when bathers are present, without concern of causing irritation. “Frequent incremental feed,” as used herein, refers to a feed of at least one cycle per day.

The oxidizing composition 2 may be used alone or can be combined with traditional detergent formulations contain: surfactants, builders, chelants, dispersants, alkalinity builders and the like. More information about the solvent-activated reactors are provided in U.S. patent application Ser. No. ______ [Attorney Docket No. 2503159-991261 filed on Sep. 3, 2004], which is incorporated herein by reference in its entirety.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention.

1. An oxidizing composition comprising:
a reactor wall enclosing a reactor space, wherein the reactor wall allows permeation of a main solvent into the reactor space at a controlled rate;
an oxidizer reactant in the reactor space, wherein the oxidizer reactant generates an oxidizing product through a chemical reaction in the reactor space when contacted by the main solvent;
a halogen component; and
a barrier material separating the oxidizer reactant from the halogen component.

2. The composition of claim 1, wherein the oxidizer reactant is about 4 to about 80 wt. % of the oxidizing composition.

3. The composition of claim 1, wherein the halogen component is about 20 to about 99.5 wt. % of the oxidizing composition.

4. The composition of claim 1, wherein the barrier film is about 0.2 to about 10 wt. % of the oxidizing composition.

5. The composition of claim 1, wherein the halogen component comprises one or more of calcium hypochlorite, trichloroisocyanurate, dichloroisocyanurate, lithium hypochlorite, dibromo-dimethylhydantoin, bromo-chloro-dimethylhydantoin, sodium bromide, sodium chloride, and a combination thereof.

6. The composition of claim 1, wherein the barrier material includes an inorganic salt, silicate, borosilicate, an organic polymer, or a combination thereof.

7. The water treatment composition of claim 6, wherein the inorganic salt comprises sodium; carbonate, bicarbonate, hydroxide, oxide, silicate, borate, potassium; carbonate, bicarbonate, hydroxide, oxide, silicate, borate, magnesium; carbonate, bicarbonate, hydroxide, oxide, silicate, borate, calcium; carbonate, bicarbonate, hydroxide, oxide, silicate, borate, or a combination thereof.

8. The composition of claim 6, wherein the silicate comprises sodium, potassium, lithium, alkyl silicate, borosilicate, or a combination thereof.

9. The composition of claim 6, wherein the organic polymer comprises chitin, chitosan, polymaleic acid, phosphinocarboxylic acid, carboxylate-sulfonate copolymer, a carboxylate-sulfonate terpolymer, polysiloxane, or a combination thereof.

10. The water treatment composition of claim 9, wherein the carboxylate component of the carboxylate-sulfonate copolymer or the carboxylate-sulfonate terpolymer is derived from either polyacrylic acid, polymethacrylic acid or polymaleic acid.

11. The water treatment composition of claim 9, wherein the sulfonate portion of the carboxylate-sulfonate copolymer or the carboxylate-sulfonate terpolymer is derived from an aliphatic or aromatic compound.

12. The water treatment composition of claim 11, wherein the aliphatic compound comprises methacrylamido methyl propane sulfonic acid.

13. The composition of claim 11, wherein the aromatic compound comprises styrene sulfonic acid.

14. The composition of claim 1, wherein the oxidizer reactant is a peroxygen compound.

15. The composition of claim 1, wherein the oxidizer reactant is selected from a group consisting of perborates, percarbonates, sodium peroxide, lithium peroxide, calcium peroxide, magnesium peroxide, urea peroxide, perphosphate, persilicate, monopersulfate, and persulfate.

16. The composition of claim 1, wherein the halogen component is one or more of calcium hypochlorite, trichloroisocyanurate, dichloroisocyanurate, lithium hypochlorite, dibromo-dimethylhydantoin, bromo-chloro-dimethylhydantoin, sodium bromide, sodium chloride, and a combination thereof.

17. The composition of claim 1, wherein the halogen component and the barrier material are in the reactor space.

18. The composition of claim 17, wherein barrier material is deposited over the oxidizer reactant.

19. The composition of claim 18, wherein the halogen component is deposited over the barrier material.

20. The composition of claim 19, wherein the barrier material is deposited over the halogen component.

21. The composition of claim 20, wherein the oxidizer reactant is deposited over the barrier material.

22. The composition of claim 1, wherein the halogen component is deposited over the reactor wall.

23. The composition of claim 1, wherein the reactor wall comprises one of a silicate-based material, a hydrophobic polymer, and a porous membrane.

24. The composition of claim 1, wherein the reactor wall dissolves after the chemical reaction is complete.

25. The composition of claim 1, wherein the oxidizing product is one or more of dioxirane, percarboxylic acid, hydroxyl radicals, chlorine dioxide, N-halo-amine, hypohalite, and singlet oxygen.

26. The composition of claim 1 further comprising a peroxygen compound, wherein the barrier material separates the peroxygen compound from the halogen component.

27. The composition of claim 26, wherein the proxygen compound is coated with the barrier material.

28. An oxidizing composition comprising:
a reactor wall enclosing a reactor space, wherein the reactor wall allows permeation of a main solvent into the reactor space at a controlled rate;
an oxidizer reactant in the reactor space, wherein the oxidizer reactant generates an oxidizing product through a chemical reaction in the reactor space when contacted by the main solvent; and
a halogen component deposited over the reactor wall.

29. The composition of claim 28, wherein the reactor wall comprises one of a silicate-based material, a hydrophobic polymer, and a porous membrane.

30. The composition of claim 28, wherein the halogen component is one or more of calcium hypochlorite, trichloroisocyanurate, dichloroisocyanurate, lithium hypochlorite, dibromo-dimethylhydantoin, bromo-chloro-dimethylhydantoin, sodium bromide, sodium chloride, and a combination thereof.

31. The composition of claim 28, wherein the oxidizing product is at least one of dioxirane, percarboxylic acid, hydroxyl radicals, chlorine dioxide, N-halo-amine, hypohalite, and singlet oxygen.

32. The composition of claim 28 further comprising a peroxygen compound between the reactor wall and the oxidizer reactant.

33. An oxidizing composition comprising:
a reactor having pores, wherein the reactor includes:
a core containing an oxidizer reactant that generates an oxidizing product when contacted by a main solvent, the core being about 10-80 wt. % oxidizer reactant; and
a reactor wall surrounding the core and controlling diffusion of the main solvent to the core through the pores, wherein the reactor wall has a substantially lower solubility in the main solvent than the oxidizer reactant and the oxidizing product such that the reactor wall remains substantially intact until generation of the oxidizing product is substantially complete; and
a halogen component in contact with the main solvent, the halogen component being is one or more of calcium hypochlorite, trichloroisocyanurate, dichloroisocyanurate, lithium hypochlorite, dibromo-dimethylhydantoin, bromo-chloro-dimethylhydantoin, sodium bromide, sodium chloride, and a combination thereof.

34. The composition of claim 33 further comprising a peroxygen compound in contact with the main solvent.

35. A method of preparing an oxidizing composition, the method comprising:
forming a reactor wall that encloses a reactor space, wherein the reactor wall allows permeation of a main solvent into the reactor space at a controlled rate;
placing an oxidizer reactant in the reactor space; wherein the oxidizer reactant generates an oxidizing product through a chemical reaction in the reactor space upon being contacted by the main solvent;
forming a section of halogen component; and
forming a layer of barrier material between the oxidizer reactant and the halogen component to keep the barrier material separated from the oxidizer reactant.

36. The method of claim 35 further comprising placing the section of halogen component and the barrier material in the reactor space.

37. The method of claim 36 further comprising depositing the barrier material over the oxidizer reactant.

38. The method of claim 37 further comprising depositing the halogen component over the barrier material.

39. The method of claim 36 further comprising depositing the barrier film over the halogen component.

40. The method of claim 39 further comprising depositing the oxidizer reactant over the halogen component.

41. The method of claim 35 further comprising depositing the halogen component over the reactor wall.

42. The method of claim 35 further comprising forming a section of peroxygen compound, wherein the section of peroxygen compound such that the barrier material is between the peroxygen compound and the halogen component.

43. The method of claim 42 further comprising depositing the barrier material on the peroxygen compound.

44. A method of preparing an oxidizing composition, the method comprising:
forming a reactor wall enclosing a reactor space, wherein the reactor wall allows permeation of a main solvent into the reactor space at a controlled rate;
placing an oxidizer reactant in the reactor space, wherein the oxidizer reactant generates an oxidizing product through a chemical reaction in the reactor space when contacted by the main solvent; and
depositing a halogen component over the reactor wall.

45. The method of claim 44 further comprising placing a peroxygen compound between the oxidizer reactant and the reactor wall.
